(19) United States
(12) Patent Application Publication
(10) Pub. No.: US 2023/0351176 A1
(43) Pub. Date: Nov. 2, 2023

(54) MACHINE-LEARNING-GUIDED ISSUE RESOLUTION IN DATA OBJECTS

(71) Applicant: Oracle International Corporation, Redwood Shores, CA (US)

(72) Inventors: Jennifer Darmour, Seattle, WA (US); Jingyi Han, San Jose, CA (US); Mark Pearson, Redwood Shores, CA (US)

(73) Assignee: Oracle International Corporation, Redwood Shores, CA (US)

(21) Appl. No.: 18/166,081

(22) Filed: Feb. 8, 2023

Related U.S. Application Data
(60) Provisional application No. 63/337,272, filed on May 2, 2022.

(51) Int. Cl. G06N 3/08

(52) U.S. Cl. CPC G06N 3/08

(57) ABSTRACT

Techniques for using a machine learning model to recommend remediation actions for issues identified in data objects are disclosed. A system applies a machine learning model to data representing one or more data objects to generate recommendations for remediating issues in the one or more data objects. The machine learning model is trained on training datasets of historical data object records. The training dataset identifies issues arising from the modifications and remediation actions addressing the issues. The system trains the machine learning model to learn correlations between identified issues and recommended remediation actions. The trained machine learning model recommends remediation actions for particular sets of data object data. The system presents the recommendations, together with a display of the data object, in a graphical user interface.

### INCORPORATION BY REFERENCE; DISCLAIMER

The following application is hereby incorporated by reference: application No. 63/337,272, filed May 2, 2022. The applicant hereby rescinds any disclaimer of claims scope in the parent application(s) or the prosecution history thereof and advise the USPTO that the claims in the application may be broader that any claim in the parent application(s).

### TECHNICAL FIELD

The present disclosure relates to machine-learning-guided anomaly resolution in data objects, such as spreadsheets. In particular, the present disclosure relates to training at least one machine learning model to assist a user to identify and remediate anomalies in spreadsheets and database records.

### BACKGROUND

People prefer to use spreadsheets because they are easy to use, intuitive, and display a significant amount of information in an organized manner. Information in a database is frequently stored in tables of rows and columns defining fields, similar to spreadsheets. However, conventional database access applications lack the range of functions that spreadsheet applications provide. In addition, conventional database systems access data in the database by querying the database to obtain sets of records and/or values matching query terms. Due to the quantities of data stored in databases and spreadsheets, identifying particular data that may require some form of remediation is time-consuming and difficult to achieve.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for training a machine learning model to recommend remediation actions for issues in data objects in accordance with one or more embodiments;

FIGS. 3A and 3B illustrate an example user interface for providing recommended remediation actions for issues in data objects in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. MACHINE LEARNING ASSISTED REMEDIATION OF ISSUES IN DATA OBJECTS
4. EXAMPLE EMBODIMENT
5. ADDING ATTACHMENTS TO DATABASE RECORDS
6. DRAG-AND-DROP SPREADSHEET SECTION TO GENERATE NEW DATABASE RECORDS
7. COMPUTER NETWORKS AND CLOUD NETWORKS
8. MISCELLANEOUS; EXTENSIONS
9. HARDWARE OVERVIEW

### 1. General Overview

One or more embodiments implement a machine learning model for suggesting updates to a set of objects. The system trains a machine learning model using training data sets. A training data set may include a set of one or more objects associated with an issue. The issue may be, for example, a data inconsistency between different objects or between different components of a same object. The training data set may further include information indicating a remediation action for addressing the issue. Once trained, the machine learning model may be applied to a target data set of one or more objects to generate a suggestion for remediating an issue with the target data set.

As an example, a training set includes flight-related data objects corresponding to an airplane flight. A first flight-related object corresponding to the flight may identify a planned departure time in the future for the flight. A second flight-related object corresponding to the flight may identify the status of the flight as “departed”. In this example, the two data objects are inconsistent as a flight that has already departed cannot have a planned departure time in the future. The training set may further include information indicating a remediation action to address the inconsistency between the data objects. The remediation action may be an action to update the planned departure time to “not applicable” since the flight has already departed. Alternatively, or in addition, the information in the training set may include an updated version of the data objects such that the first object includes a “not applicable” value for the planned departure time and the second object still identifies the status of the flight as “departed.” Once trained, the machine learning model may be applied to a target set of objects to generate suggestions for remediating an issue(s) with the target set of objects. Continuing the example, the trained machine learning model may be applied to a target set of objects corresponding to another flight. The target set of objects includes a planned departure time object that indicates a time of planned departure in the future. The target set of objects further includes a flight status object that identifies the flight as “departed.” The trained machine learning model, when applied to the target set of objects, generates a suggestion to update the planned departure time object to “not applicable.”

According to another example, a training set includes product-manufacturing related data objects corresponding to a product line. A first field in a record of an object may identify a dependency of the record on another record. However, the other record may be omitted from the data object. In this example, the data object includes an issue that one record depends on another record that does not exist. According to yet another example, a field in a record for a particular component may contain no value associated with a “quantity” attribute of the component. In this example, the data object includes an inconsistency of an absence of a required value. The training set may include information indicating remediation actions to address the inconsistencies among records in the data object. In the example of a record depending from a non-existent record, the remediation action may be to: (a) delete the dependency indicated in the existing record, or (b) create a new record in the data object. In the example of the field missing a required value, the remediation action may be to populate the field with a particular value.

In another example, the machine learning model is trained on training datasets of historical data object records. The training datasets may include database change logs. The logs may describe database content and modifications to database content. The training dataset identifies issues arising from the modifications and remediation actions addressing the issues. The system trains the machine learning model to learn correlations between identified issues and recommended remediation actions. The trained machine learning model recommends remediation actions for particular sets of data object data. For example, when a user opens a representation of a data object in a GUI, the system may (a) apply a set of rules to identify issues in the data object, and (b) apply the machine learning model to data representing the data object to generate remediation action recommendations. As an example, the system may identify blank fields that should contain values, fields that contain conflicting values, or a data object structure that should include one or more additional or fewer rows or columns associated with one or more additional database records or attributes. The machine learning model generates recommendations for remediating the identified issues.

One or more embodiments present recommendations for remediating issues in data objects in a GUI. The GUI includes a first region displaying data object contents and a second region displaying recommended remediation actions. For example, the GUI may display the recommended remediation actions as tiles selectable by a user to initiate remediation actions. Selection of a tile representing a remediation action in the second region causes the GUI to modify the displayed data in the first region. Prior to receiving a selection of a tile, the GUI may display a first set of records in the first region. Subsequent to receiving the selection, the GUI may display a second set of records that includes at least one record associated with the remediation action corresponding to the selected tile. For example, a user selection of a tile associated with an issue “missing quantity” causes the system to modify the content displayed in the first region from a first set of records to a second set of records including at least one record in which a “quantity” attribute is missing. The system highlights the particular record. The system also generates a selectable user interface element to present a particular value to be entered into a field corresponding to the “quantity” attribute. The system obtains the particular value from the machine learning model recommendation. The system guides a user through recommended remediation actions. Upon remediating issues associated with one tile in the first region of the GUI, the system opens the next tile and displays records associated with the issue and remediation action identified in the next tile.

One or more embodiments present in the GUI a subset of issues for which the machine learning model generates remediation actions. The system selects the subset to be displayed based on priority values assigned to one or both of the remediation actions and the issues underlying the remediation actions. In one embodiment, the machine learning model generates the priority values together with the recommendations for remediating issues.

One or more embodiments described in this Specification and/or recited in the claims may not be included in this General Overview section.

### 2. System Architecture

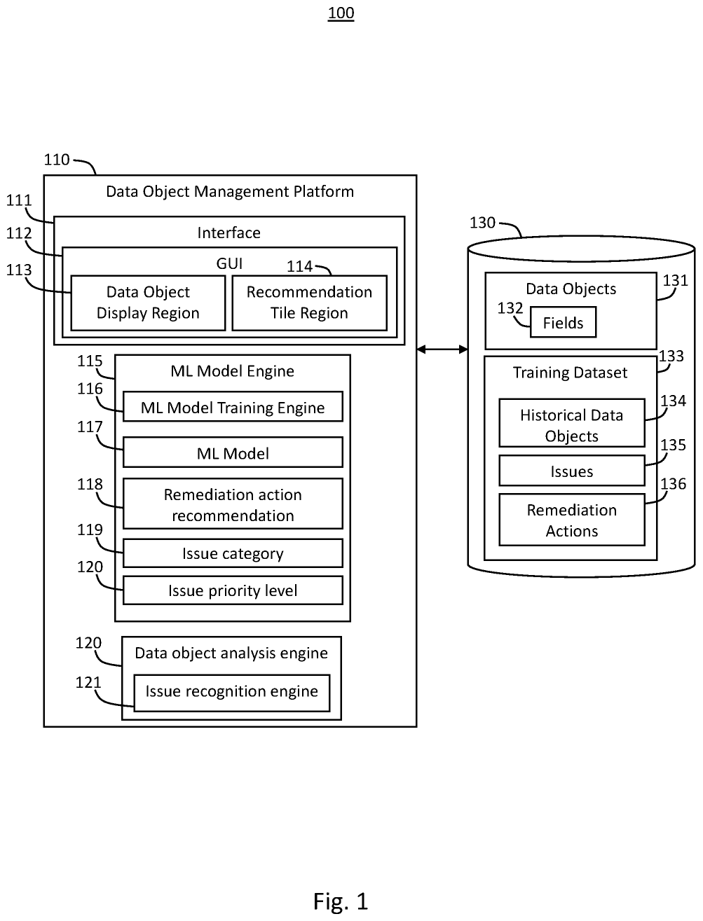

FIG. 1 illustrates a system 100 in accordance with one or more embodiments. As illustrated in FIG. 1, system 100 includes a data object management platform 110 and a data repository 130, which may include, for example, a database. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The data object management platform 110 accesses data objects 131 from the data repository 130. Data objects 131 include table-type data objects including fields 132 storing values. According to one embodiment, the data objects include database tables representing one or more database records. The data object management platform 110 displays data objects 131 via a graphical user interface (GUI) of an interface 111. The interface 111 includes the GUI 112, which displays the data objects 131 and other interface elements. The interface 111 includes user input devices to allow a user to interface with interface elements displayed on the GUI 112.

According to one or more embodiments, the GUI 112 displays data object fields in a first region 113 of the display. The GUI 112 displays tiles identifying issues and providing recommendations for remediating issues in another region 114 of the display.

According to one embodiment, the data objects 131 are stored in a database. The data object management platform 110 populates the data object display region 113 with data obtained from one or more data objects 131 based on queries to the database at run-time.

In one or more embodiments, interface 111 refers to hardware and/or software configured to facilitate communications between a user and the data object management platform 110. Interface 111 renders user interface elements and receives input via user interface elements. In addition to the GUI 112, the interface 111 may include a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 111 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 111 is specified in one or more other languages, such as Java, C, or C++.

The data object management platform 110 includes a data object analysis engine 120. The data object analysis engine 120 performs an analysis of the content of data objects 131. The analysis may include, for example, analyzing a table format, analyzing field types, analyzing values for particular fields, comparing values of different fields to each other and/or to threshold values, and applying sets of rules to the data objects 131. An issue recognition engine 121 identifies issues with the data object 131, or sets of data objects 131, based on the analysis by the data object analysis engine 120. For example, the issue recognition engine 121 may: identify a missing value from a field requiring a value, identify a value in one field that conflicts with a value in another field based on applying a rule associated with the fields, and identify a value in a set of fields of one database record, specifying hierarchal attributes of the database record, that conflicts with another value in another field specifying the hierarchal attributes of another database record. According to one embodiment, the issue recognition engine 121 identifies issues by applying defined sets of rules to one or more data objects. In addition, or in the alternative, a machine learning model 117 may be trained to identify issues in data objects. For example, the ML model 117 may be trained on datasets of historical data object change logs. The ML model 117 may learn relationships among different values, fields, and data objects. Accordingly, when an embedding representing particular values and/or a particular data object is provided to the ML model 117 as input data, the ML model 117 may identify, based on learned historical patterns, issues that a user may choose to resolve in the particular data object.

A machine learning model engine 115 includes a training engine 116 for training a machine learning model 117. The machine learning model engine 115 applies the machine learning model 117 to data objects 131 to identify remediation actions for issues in the data objects 131.

A machine learning model training engine 116 trains a machine learning model 117 to recommend remediation actions 118 associated with issues identified in data objects 131. According to one or more embodiments, the machine learning model engine 115 may further train the machine learning model 117 to (a) identify issues in data objects, (b) identify categories associated with issues, and (c) generate a priority level ranking for issues.

In some examples, one or more elements of the machine learning model engine 115 may use a machine learning algorithm to recommend remediation actions 118 associated with issues identified in data objects 131. A machine learning algorithm is an algorithm that can be iterated to learn a target model f that best maps a set of input variables to an output variable, using a set of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, a set of training data includes training datasets 133 and associated labels. The training datasets 133 include historical data objects 134. The datasets 133 are associated with input variables (e.g., data object attributes, field values, field types, issues 135 in data objects) for the target model f. The associated labels are associated with the output variable (e.g., remediation actions 136, issue categories, issue priority levels, and in some embodiments, issues based on data object attributes) of the target model f. The training data may be updated based on, for example, feedback on the accuracy of the current target model f Updated training data is fed back into the machine learning algorithm, which in turn updates the target model f

A machine learning algorithm generates a target model f such that the target model f best fits the datasets of training data to the labels of the training data. Additionally, or alternatively, a machine learning algorithm generates a target model f such that when the target model f is applied to the datasets of the training data, a maximum number of results determined by the target model f matches the labels of the training data.

In an embodiment, a machine learning algorithm can be iterated to learn remediation actions associated with issues in data objects. In an embodiment, a set of training data includes data object attributes and issues identified in the data objects. The issues are associated with labels, indicating remediation actions for the particular issues. In another embodiment, a machine learning algorithm can be iterated to learn issues associated with attributes, such as values and/or formatting in data objects. In an embodiment, a set of training data includes data object attributes and issues identified in the data objects. The attributes are associated with labels, indicating issues in the particular data for the particular data object. In yet another embodiment, a machine learning algorithm can be iterated to learn categories and priority levels associated with issues in data objects. In an embodiment, a set of training data includes data object attributes and issues identified in the data objects. The issues are associated with labels, indicating a category and priority level for the particular issue.

According to one or more embodiments, the data object analysis engine 120 performs an analysis of one or more data objects to identify issues with the data objects in response to a triggering event. For example, the data object management platform 110 may initiate analysis of a data object being displayed in a graphical user interface 112. The data object management platform 110 may receive an instruction to analyze stored data objects 131 which may or may not be displayed data objects. The data object management platform 110 may be programmed to run a scheduled routine for identifying issues in stored data objects. According to another example, the data object management platform 110 may detect when a user or program changes values in data objects and may automatically, without intervening user input, perform an analysis of the data objects involved in the changes. For example, a user may merge two tables to add or combine values from one table to, or with, values and fields of another table. The data object analysis engine 120 may perform an analysis of the resulting table to identify issues in the merged table.

Additional embodiments and/or examples relating to computer networks are described below in Section 7, titled “Computer Networks and Cloud Networks.”

In one or more embodiments, a data repository 130 is any type of storage unit and/or device (e.g., a file system, database, collection of tables, or any other storage mechanism) for storing data. Further, a data repository 130 may include multiple different storage units and/or devices. The multiple different storage units and/or devices may or may not be of the same type or located at the same physical site. Further, a data repository 130 may be implemented or may execute on the same computing system as the data object management platform 110. Alternatively, or additionally, a data repository 130 may be implemented or executed on a computing system separate from the data object management platform 110. A data repository 130 may be communicatively coupled to the data object management platform 110 via a direct connection or via a network.

Information describing the data objects 131 and the machine learning model training datasets 133 may be implemented across any of components within the system 100. However, this information is illustrated within the data repository 130 for purposes of clarity and explanation.

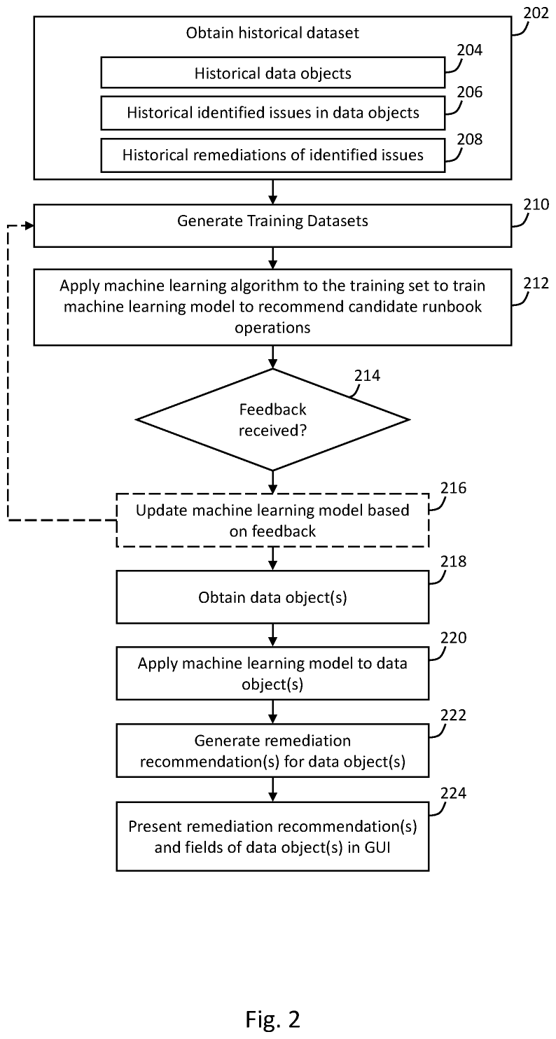

In one or more embodiments, the data object management platform 110 refers to hardware and/or software configured to perform operations described herein for displaying data objects and applying a machine learning model to recommend actions for remediating issues with the data objects. Examples of operations for using a machine learning model to generate recommendations for remediating issues in data objects are described below with reference to FIG. 2.

In an embodiment, the data object management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Generating Recommendations for Remediating Issues in Data Objects with a Machine Learning Model

FIG. 2 illustrates an example set of operations for generating recommendations for remediating issues in data objects using a machine learning model in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system obtains a dataset of historical data object information (Operation 202). For example, the system may obtain change logs, database image files, differential-type files showing a change in state from one set of stored values to another, or a set of values stored in a database table at a particular moment in time. The dataset may include actual historical files and synthetically-generated files having the structure and appearance of database files for the purposes of machine learning model training.

According to one or more embodiments, the historical dataset includes historical data objects 204, historical issues 206 identified in the data objects, and historical remediations 208 of the issues. For example, a particular set of database image data may include a label indicating a particular set of two values are in conflict, and a label indicating a particular remediation action (such as modifying one value, replacing a value, deleting a value, generating a notification to obtain user input, adding a field, adding a column or row to a table, performing a logical or mathematical calculation to obtain a new value, etc.). According to one example embodiment, the historical dataset includes remediation actions performed by users historically to address particular issues in data objects. For example, the historical dataset may identify a conflict between two values in a database table. The historical dataset includes a record associated with a user modifying one of the values in a particular way to remediate the conflict. According to another example, the historical dataset includes a changelog of a database object in which a new record is generated in the object with an empty field. The historical dataset includes a record of a value entered by a user in the field to remediate the issue of the empty field in the newly-generated record. According to another example, the historical dataset includes a record of a spreadsheet-type document from a spreadsheet application interfacing with a database table to modify values stored in the database table with values from the spreadsheet. The historical dataset includes a record of one or more new columns being generated in the database table corresponding to one or more columns from the spreadsheet that were absent from the database table.

Once the various data (or subsets thereof) are identified in Operation 202, the system generates training datasets (operation 210). The training datasets include particular sets of the historical data objects and corresponding labels for remediation actions. The training datasets may be selected to have a particular number, such as 10,000, 50,000, or more data objects to be trained on, to include particular types of data objects, particular identified issues in the data objects, and/or particular remediation actions. For example, a machine learning model trained for a particular type of database may include a larger sample of training data from that type of database than other types of databases. Generating the training datasets may include converting table-type data into embeddings comprising vectors. The vectors may be numerical representations of words and numbers stored in data objects. One or more vectors may represent structural information about the data objects. One or more vectors may represent information about a database in which a data object was stored. Embeddings may include data from one or more data objects. For example, a historical record of a merger of two data objects may include data, converted to vectors in an embedding, about the two data objects.

The system applies a machine learning algorithm to the training data set (Operation 212). The machine learning algorithm analyzes the training data set to identify data and patterns that indicate relationships between identified issues in data objects and remediation actions performed. Types of machine learning models include, but are not limited to, linear regression, logistic regression, linear discriminant analysis, classification and regression trees, naïve Bayes, k-nearest neighbors, learning vector quantization, support vector machine, bagging and random forest, boosting, backpropagation, and/or clustering.

Training a neural network includes: (a) obtaining a training data set, (b) iteratively applying the training data set to a neural network to generate labels for data points of the training data set, and (c) adjusting weights and offsets associated with the formulae that make up the neurons of the neural network based on a loss function that compares values associated with the generated labels to values associated with test labels. The neurons of the neural network include activation functions to specify bounds for a value output by the neurons. The activation functions may include differentiable nonlinear activation functions, such as rectified linear activation (ReLU) functions, logistic-type functions, or hyperbolic tangent-type functions. Each neuron receives the values of each neuron of the previous layer, applies a weight to each value of the previous layer, and applies one or more offsets to the combined values of the previous layer. The activation function constrains a range of possible output values from a neuron. A sigmoid-type activation function converts the neuron value to a value between 0 and 1. A ReLU-type activation function converts the neuron value to 0, if the neuron value is negative, and to the output value if the neuron value is positive. The ReLU-type activation function may also be scaled to output a value between 0 and 1. For example, after applying weights and an offset value to the values from the previous layer for one neuron, the system may scale the neuron value to a value between −1 and +1. The system may then apply the ReLU-type activation function to generate a neuron output value between 0 and 1. The system trains the neural network using the training data set, a test data set, and a verification data set until the labels generated by the trained neural network are within a specified level of accuracy, such as 98% accuracy.

According to one or more embodiments, training the machine learning model includes identifying a particular remediation for an issue associated with a non-mathematical relationship between different data objects or between different components of the same data object. For example, the machine learning model may be trained to identify a relationship between a data object with a first set of columns representing attributes and another data object with a separate set of columns representing a separate set of attributes. In addition, or in the alternative, training the machine learning model includes identifying a particular remediation for an issue associated with a mathematical relationship between different data objects or between different components of the same data object. For example, the machine learning model may be trained to identify a relationship between a particular numerical value in one field of a data object and a numerical value in another field of the data object. The machine learning model may learn the relationship between the data objects and/or components within a data object based on being trained with multiple datasets including the mathematical and/or non-mathematical relationship between data objects and/or between components of one data object.

In examples of supervising machine learning algorithms, the system may obtain feedback on the whether a particular remediation action should be associated with a particular issue identified in a data object (Operation 214). The feedback may affirm that a particular remediation action should be performed or recommended when a particular issue is detected in the data object. In other examples, the feedback may indicate that a particular instance of a remediation action should not be associated with the corresponding issue(s). Based on the feedback, the machine learning training set may be updated, thereby improving its analytical accuracy (Operation 216). Once updated, the system may further train the machine learning model by optionally applying the model to additional training data sets.

Upon training the machine learning model, the system obtains a particular data object (Operation 218). The particular data object may be selected by a user, presented on a graphical user interface display, or stored in a data repository. Obtaining the particular data object may include detecting a trigger associated with the data object. For example, the system may identify a data object for issue analysis based on determining that data has been modified in the data object. In addition, or in the alternative, a system may analyze database records for issues on a predefined schedule. In additional embodiments, the system may detect any criterion to determine whether to detect issues and generate remediation recommendations, such as: detecting a particular type of modification (such as addition, deletion, and modification of values in specified fields), detecting a modification from a particular source (such as a user with a particular authorization level), and detecting creation of a particular type of data object.

The system applies the machine learning model to the data object(s) (Operation 220). For example, the system may generate an embedding representing at least one of (a) an entire data object, such as an entire spreadsheet or an entire database table, (b) a predefined set of values in data object, such as values identified as being modified and related values. The embedding includes vectors that convert stored values in fields of the data object into vector-type values, such as numerical values.

The machine learning model generates one or more recommendations for remediating issues in the data object(s) (Operation 222). Examples of recommendations for remediating issues include: changing a value in a field of a data object, generating a notification (such as an interface element on a GUI) recommending a particular change to a value in a field of a data object, recommending creation of a particular type of data object, recommending an alteration to a structure of a data object, such as adding/removing a particular row, column, or record.

The system presents the recommendation(s) for remediating one or more issues together with fields of the data object(s) in a GUI (Operation 224). According to one embodiment, the system generates a GUI display with two distinct regions. In one region is a display of the contents of the data object, such as fields arranged in rows and columns with values stored in the fields. In another region alongside the first region, the system generates a display of user interface elements corresponding to recommended actions for remediating issues in the data object. A user interaction with the user interface elements in one portion of the GUI results in a modification to the other portion of the GUI. For example, a user interface element may include a tile-type icon. A user selection of the tile-type icon may: (a) change a set of displayed rows and/or columns of a table to include rows, columns, and/or fields associated with a remediation recommendation, (b) highlight the rows, columns, and/or fields associated with a remediation recommendation, and (c) highlight additional rows, columns, and/or fields that are not the source of the remediation action (e.g., do not have an identified issue), but would be affected by implementation of the remediation action. For example, performing a remediation action to change a value in a field of a parent-type row may affect a value in a child-type row. Accordingly, the system may display the child-type dependent row together with the row including the field in which an issue was detected and for which remediation action is being recommended.

According to one embodiment, in addition to displaying a table-type display, such as a spreadsheet-type display of data object contents, in one region of a GUI, the system displays the recommended remediation action at a location over the row, column, and/or field corresponding to the recommendation. For example, a user may select a tile in one region of a GUI indicating a particular conflicting value in a field of a table. The system modifies the display in the other region of the GUI to: (a) display a row, column, and/or field associated with the recommendation, and (b) display a window on or in the vicinity of the row, column, and/or field describing the recommended remediation action. The window may include a selectable user interface element. When a user selects the user interface element, the system initiates the remediation action associated with the row, column, and/or field.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

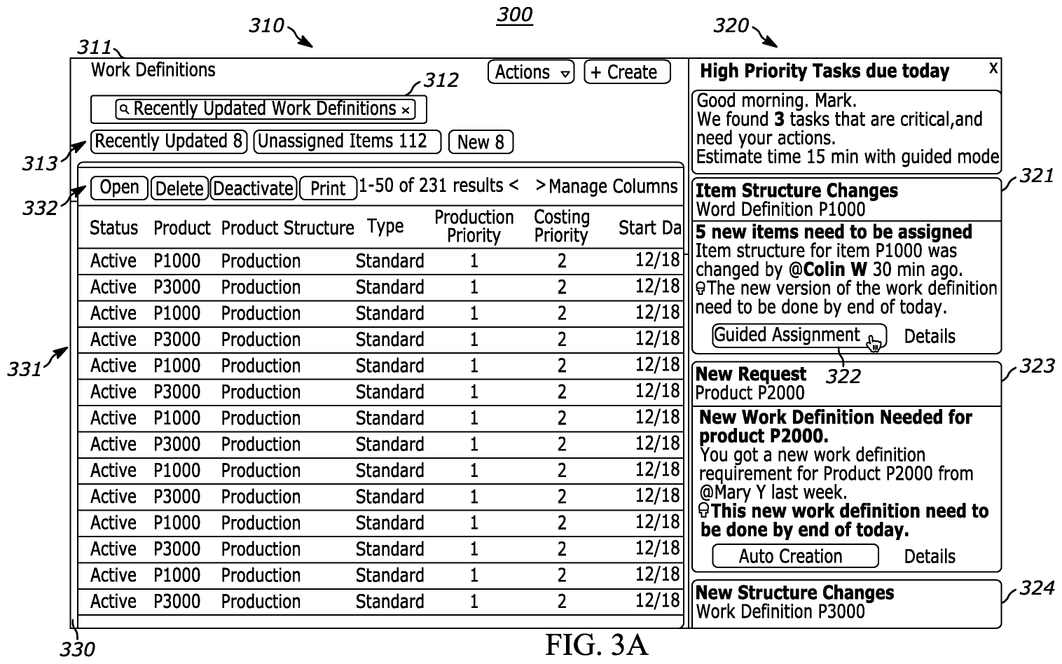

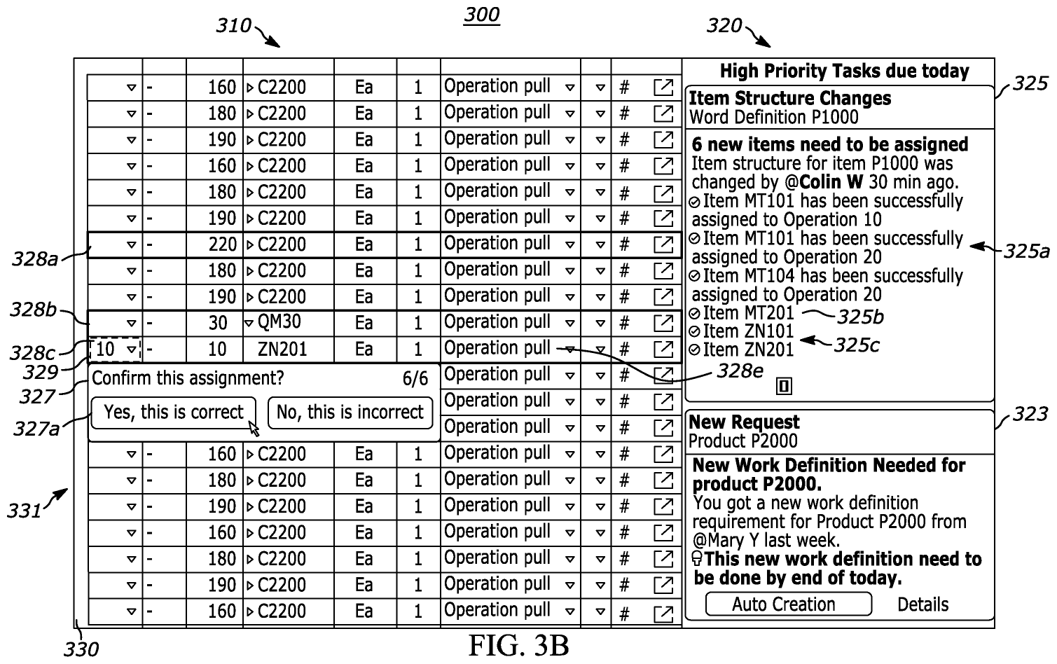

FIGS. 3A and 3B illustrate a modifying a graphical user interface display 300 to present and implement recommended remediation actions associated with a table stored in a database.

Referring to FIG. 3A, a system displays a graphical user interface (GUI) including a first region 310 and a second region 320. The first region 310 is a data object display region 310. In the example embodiment illustrated in FIG. 3A, the data object is a database table 330. The database table 330 includes a set of records 331. The table 330 is arranged in rows and columns. Each row corresponds to a database record. Each record corresponds to a work definition for a production operation scheduled for a particular product. Each intersection of a row and column defines a field. Each field stores a value. The columns include: “Status,” “Product,” “Product Description,” “Type,” and “Product Priority.” The fields of each record store values for the particular headings. For example, the field in each record that falls in the “Product” column includes a value indicating a particular product associated with the particular database record represented by the corresponding row of the database table 330. The first region 310 includes selectable user interface elements 332 to initiate actions on the records 331. For example, a user may select an icon to open a database record, delete a record, deactivate a work definition, or print a database record.

The first region 310 also includes a header 311. The header 311 includes a name of the database table 330 (i.e., “Work Definitions”). The header includes a search field 312. A user interacts with the search field to enter search terms. The header 311 also includes selectable user interface elements 313 matching the search terms in the search field 312.

The second region includes a set of task tiles 321, 323, and 324. The task tiles 321, 323, and 324 are selectable user interface elements. When a user selects a task tile, the system modifies the data displayed in the first region 310 based on the selected task tile 321.

The task tile 321 includes a title “Item Structure Changes.” The task tile 321 indicates there are five database records in the database object represented by the first region 310 which require a particular assignment. Selection of the main body of the task card 321 results in modifying the records 331 displayed in the first region 310 to include one or more of the five items identified by the task tile 321. The task tile 321 includes a user interface element 322. Selection of the user interface element 322: (a) modifies the records 331 displayed in the first region 310 to include one or more of the five items identified by the task tile 321, and (b) displays recommended modifications to values in the corresponding fields to remediate the issue of assigning items structures to the identified database records.

In other words, selection of one user interface element (i.e., the “Guided Assignment” button) associated with the task tile 321 results in the system presenting a machine-learning generated recommendation for remediating the identified issue of a record requiring a value in a particular field. Selection of another user interface element (i.e., the larger task tile 321 surrounding the button 322), the system modifies the records 331 displayed in the region 310 to show one or more records corresponding to the issue “new items need to be assigned” without presenting any recommendation for remediating the issue.

In the example embodiment illustrated in FIG. 3A, the system identifies issues in the data object “work definitions.” According to one example, an issue recognition engine, such as the engine 121 of FIG. 1, applies rules to the values in the data object to identify the issues. For example, a rule may specify that, when a new record 331 is created, a value should be provided in a field associated with an “item structure” attribute. The system may identify newly-created records for which no value has been entered. The system applies data representing the data object “work definitions” to a machine learning model—such as the model 117 illustrated in FIG. 1. The machine learning model generates recommended actions for remediating issues present in the data object “work definitions.” The system generates the tiles 321, 323, and 324 based on the issues identified. For example, the machine learning model generates recommended values to enter into the fields associated with the “item structure” attribute for the newly-created records associated with the task tile 321.

The system identifies a subset of issues to display in the second region 320 based on a priority level assigned to the issues. The machine learning model may generate a priority value based on historical remediation action patterns. For example, if a training dataset indicates users have historically performed remediation actions associated with issue A prior to issue B, the machine learning model may learn (e.g., the parameters of the model may be set in the course of training the model) that the system should assign a higher priority level to issue A than issue B. The machine learning model may receive as input data additional attribute values that factor into assigning a particular priority level to a particular issue and/or remediation action, including: a particular user performing remediation actions, a type of user (e.g., administrator versus executive versus programmer) performing remediation actions, and attributes of the particular records in a data object. Based on different users signing in to access the data object management application, the system may display different subsets of task tiles in the second region 320.

When the system detects a user selection of the user interface element 322, the system modifies the display in the first region 310 to include one or more records 331 corresponding to the task tile 321. The system displays in the GUI: (a) records 328a, 328b, and 328c associated with the task tile 321. The system displays a recommended value (“10) for a field 329a in the record 328c. The recommended value (“10”) corresponds to a machine-learning-model-generated recommendation to remediate the issue “item structure changes” in the record 328c. The system generates a window 327 at a location in the first region 310 corresponding to the recommended value 329. The window 327 includes a user interface element 327a to allow a user to accept or reject modification of the record 328c to include the value 329. The system highlights the records 328a-328c from among the set of displayed records 331. Among the highlighted records 328a-328c, the system further highlights the fields 329a and 329b, from among the fields within the selected record 328c, for which the system has identified issues for remediation.

As the system detects resolution of issues associated with a task tile 321, the system modifies the task tile, as indicated by the updated task tile 325 of FIG. 3B, to indicate that particular instances of the identified issue have been remediated. The task tile 325 displays previously-resolved instances 325a of the issue. The task tile further displays the presently-selected instance 325b of the issue. The task tile 325 further displays additional instances 325c of the issue that are not yet selected for remediation.

According to one example embodiment, selection by a user of the interface element 327a confirming or rejecting a proposed modification to the data object “work definitions” results in the system updating the task tile 325. For example, an icon associated with the presently-selected instance 325b may be modified to indicate the issue has been remediated. The system may modify, without additional user input navigating the database table 330, the database table 330 to display a record corresponding to a next instance 325c of the issue. The system may further modify an icon associated with the next instance 325c in the task tile to indicate the next instance 325c is now the currently-selected instance. Modifying the icon may include highlighting the icon and/or changing the icon from one shape to another shape.

According to the example embodiment illustrated in FIGS. 3A and 3B, a system uses a machine learning model to guide a user through a process of remediating issues in data objects stored in a database system. The system applies the machine learning model to an embedding representing the structure and values of the data object “work definitions.” The machine learning model generates recommended remediation actions for issues identified in the data object “work definitions.” The system presents the recommended remediation actions using task tiles in one region of a graphical user interface while presenting records of the data object in another region of the GUI. Based on user interaction with the task tiles, the system modifies (a) the records displayed in the records region, (b) an appearance of records in the records region to highlight records associated with a selected task tile, and (c) values in fields of the records displayed in the records-display region based on values generated by the machine-learning model.

In addition to modifying values in fields of data objects, one or more embodiments modify a structure of database records including: adding a new record, deleting a record, and adding a column associated with an attribute. For example, a machine learning model may learn that for data objects including a value X in a field for an attribute AA, the record should include a value Yin a field associated with an attribute BB. If the attribute BB does not exist in the data object to which the machine learning model is presently applied, the machine learning model may generate a recommendation to add a new column in the data object, the new column corresponding to the attribute BB. The machine learning model may further recommend providing a particular value in the field corresponding to the proposed new attribute BB. The system may generate a task tile representing the recommendation and display the task tile in a task tile region alongside a records-display region of a GUI.

### 5. Adding Attachments to Database Records

One or more embodiments store a document in association with a particular database record in response to a user dragging the document to a table row corresponding to the particular database record.

A database record may be displayed as a spreadsheet. The spreadsheet may display a set of records of the database as rows. Columns represent particular attributes of the records. A user may drag a document or file to a row of the spreadsheet. In response to a drag-and-drop action by the user, the system stores the document or file in association with a record that corresponds to the row. The system generates a live link, such as a hyperlink, in a field of the row. Selection of the link navigates a user directly to the document or file.

One or more embodiments modify contents of a database to include a file, link to a file, or address information associated with the file, based on the user's drag-and-drop action in connection with the spreadsheet displayed on the UI.

According to one or more embodiments, the modification of the contents of the database triggers an analysis of data objects stored in the database by a data object analysis engine, such as the data object analysis engine 120 of FIG. 1. The system may analyze the modified data objects to determine whether the modifications resulted in issues requiring remediation. The system may analyze additional data objects associated with the modified data objects to determine whether the modification resulting in data conflicts, data consistency, data object consistency issues, or any other issues requiring remediation. The system may apply embeddings associated with the data objects to a machine learning model, such as the model 117 in FIG. 1, to generate recommendations for remediating any issues arising from the modifications to the data objects stored in the database.

### 6. Drag-and-Drop Spreadsheet Section to Generate New Database Records

One or more embodiments create database records in response to a user dragging and dropping cells from a spreadsheet into a GUI that is illustrating existing database records as a table, such as the GUI 300 illustrated in FIGS. 3A and 3B.

Available spreadsheet applications, such as EXCEL, SHEETS, NUMBERS, LIBREOFFICE CALC, SMARTSHEET, and QUIP provide users with functionality to efficiently visualize data and apply formulas to data across multiple fields. In addition, spreadsheet applications disconnected from database tables allow users to modify data without modifying an underlying database. When users record data in a spreadsheet that they would like to transfer to a database table, the user must manually enter the data from the spreadsheet into a UI representing tables stored in a database.

According to one or more embodiments, a user may drag-and-drop cells, rows, and/or columns from a spreadsheet application into a UI representing a database table, in a database records application, to modify attributes of the database table. The system extracts information from the spreadsheet application to determine if or how to modify the database records application. The system may analyze cell contents as well as metadata associated with the cell contents. The system analyzes the characteristics of selected cells, rows, and/or columns to determine whether to (a) create new rows and/or columns, and/or (b) update values in existing cells of the database table. For example, the system may analyze metadata associated with a selected cell to determine a record name associated with the cell. The system may determine whether to create a new record or update an existing record in the database records application based on the metadata.

According to one example, a user drags-and-drops a cell from a spreadsheet application into a database record application. The system analyzes: (a) and attribute of the cell (e.g., the column header), and (b) the attribute value of the cell. If an attribute exists in the database record application that is the same as the attribute of the cell, the system (a) detects a row in which the cell was dropped, and (b) updates a value for the corresponding attribute to match the value from the spreadsheet application.

According to another example, a user drags-and-drops one or more cells, including at least one cell including identifying information associated with a particular record, from a spreadsheet application into a database record application. Identifying information associated with a particular record may include a unique identifier that distinguishes one record from another. The identifying information may include, for example, a name (e.g., “item name”), or an identifying (ID) number (e.g., a serial number). The system determines whether a record exists in the database record application having the same identifying information. If so, the analyzes: (a) and attribute of the cell (e.g., the column header), and (b) the attribute value of the cell. If an attribute exists in the database record application that is the same as the attribute of the cell, the system updates a value for the corresponding attribute in the particular record to match the value from the spreadsheet application. If the system determines that a record does not exist in the database record application with the particular identifying information, the system may create a new record in the database record application. The new record may be populated with the values dragged-and-dropped by the user from the spreadsheet application.

According to one embodiment, when the system creates a new record, the system may validate values in the new record. For example, the system may generate, based on detecting one or more unresolved issues associated with the new record, an alert indicating one or more fields of the new record require user attention. For example, a value dragged-and-dropped by the user may be an invalid value. In addition, or in the alternative, the system may notify the user that one or more fields in the newly-generated record are empty. The system may prompt the user to enter values for the one or more fields.

According to one or more embodiments, the system applies embeddings associated with modified database records to a machine learning model, such as the model 117 in FIG. 1, to generate recommendations for remediating any issues arising from the modifications to the database records.

According to another example, a user drags-and-drops one or more cells, including at least one cell including a header name associated with a particular attribute (e.g., column header), from a spreadsheet application into a database record application. According to one example, the user drags and drops only a cell including a column name into the database record application. If a column does not exist with the same column name in the database record application, the system generates a new column with the same column name in the database record application.

According to another example, the user drags and drops both a column header and values in the column from the spreadsheet application into the database record application. The system analyzes metadata associated with the values in the column. In particular, the system determines record identification information associated with the values selected by the user. In other words, if a user drags and drops a column with values 1, 1, 1, 0, 3, 4, the system may associate the values with record identification information as follows: 1: corresponds to a record with a record ID: ID123, 1: corresponds to a record with a record ID: ID124, 1: corresponds to a record with a record ID: ID125, 0: corresponds to a record with a record ID: ID126, 3: No corresponding record ID exists in the database records application, 4: corresponds to a record with a record ID: ID128.

If a column exists in the database record application having the same name as the header being dragged-and-dropped from the spreadsheet application, the system updates records in the database records application that correspond to values. In the example above, the system updates values for a column name “Item priority” for the records associated with item IDs: ID123, ID124, ID125, ID126, and ID128. If a corresponding row does not exist in the database records application that corresponds to a value in the dragged-and-dropped column, the system may generate an alert. For example, the system may prompt a user to create a new record in the database records application or discard the value.

According to one or more embodiments, the system performs operations to identify a “fuzzy match” between source spreadsheet data and database records application data, based on determining that the data is close, but not identical. For example, the system may analyze one or more of: a similarity of cell contents (e.g., a similarity of a header name in a spreadsheet to a header name in a database records application), a format of cell contents, and a position of a row, column, and/or cell relative to other rows, columns, and/or cells, to match rows, columns, and/or cells of a spreadsheet to rows, columns, and/or cells of a database records application. The system matches the rows, columns, and/or cells even when the values in the rows, columns, and/or cells are not identical. For example, the system may identify a column header “Item Type” in a spreadsheet. The system may identify a pattern of values in the column, such as each value beginning with the letters OPT or TRE. The system may identify another column header “Class” in a database records application. The system may identify the same pattern of values in the column (e.g., each entry begins with the letters OPT or TRE). Based on the pattern of values in the respective columns, the system may match the column “Item Type” of the spreadsheet application with the column “Class” of the database records application. When a user drags contents from the column “Item Type” of the spreadsheet application, the system modifies the column “Class” of the database records application.

As another example, the system may identify a column header “Sell_Date” in the spreadsheet application. The system may determine that the database records application does not include a column header “Sell_Date,” but does include a column header “Sale Date.” The system may match the column with the header “Sell_Date” in the spreadsheet with the column having the header “Sale Date” in the database records application. When a user drags contents from the column “Sell_Date” in the spreadsheet, the system modifies the column “Sale Date” in the database records application.

According to one or more embodiments, the system generates a notification to allow for user confirmation of a fuzzy match of one row, column, and/or cell to another row, column, and/or cell having a different name or value. The system may give the user the option to merge values of dragged-and-dropped cells into the fuzzy-matched rows or columns or to generate a new row or column.

According to an example embodiment, the system rearranges values from a spreadsheet to a database records application based on identifying column headers and/or record identifying information. For example, a user may select a column of values with the following relationships to corresponding record IDs: recordID1-5; recordID2-4; record ID3-0. The system may detect the record IDs in the following order in the database records application: record ID3, record ID1, record ID2. The system may rearrange the values from the spreadsheet (5, 4, 0) to correspond to the respective record IDs in the database records application (i.e., 0, 5, 4) based on matching particular values with particular record IDs. The system may update the values for the records in a column matching the column from the spreadsheet application from which the values are dragged.

While an embodiment is described above utilizing drag-and-drop functionality, one or more embodiments transfer content from a spreadsheet application to a database records application using cut-and-paste functionality.

One or more embodiments include installing a plug-in in a spreadsheet application to provide functionality to the spreadsheet application to interface with the database records application. For example, the plugin may provide the spreadsheet application with (a) functionality to display a dragged set of one or more cells as a graphic element on a UI, and (b) application programming interface (API) functions of the database records application to allow the spreadsheet application to transfer data to the database records application.

According to one or more embodiments, the modification of the contents of the database triggers an analysis of data objects stored in the database by a data object analysis engine, such as the data object analysis engine 120 of FIG. 1. The system may analyze the modified data objects to determine whether the modifications resulted in issues requiring remediation. The system may analyze additional data objects associated with the modified data objects to determine whether the modification resulting in data conflicts, data consistency, data object consistency issues, or any other issues requiring remediation. The system may apply embeddings associated with the data objects to a machine learning model, such as the model 117 in FIG. 1, to generate recommendations for remediating any issues arising from the modifications to the data objects stored in the database. In addition, the machine learning model may identify the “fuzzy match” of one data object attribute from one record, such as a spreadsheet being merged to the database data object, to another data object attribute. For example, the system may select a merger of a set of values associated with columns in a spreadsheet-type application with a data object in a database. The system may detect a name of a spreadsheet column that corresponds to, but is not the same as, a name of a column in a data object table. The machine learning model may recommend a remediation action of modifying the name of the spreadsheet column to match the attribute of the data object table. The machine-learning model may further recommend particular modifications to values in the column of the database object to merge the values of the two columns. For example, the machine learning model may recommend keeping a value in a source document, such as the spreadsheet application, and discarding a conflicting value in the destination database object.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

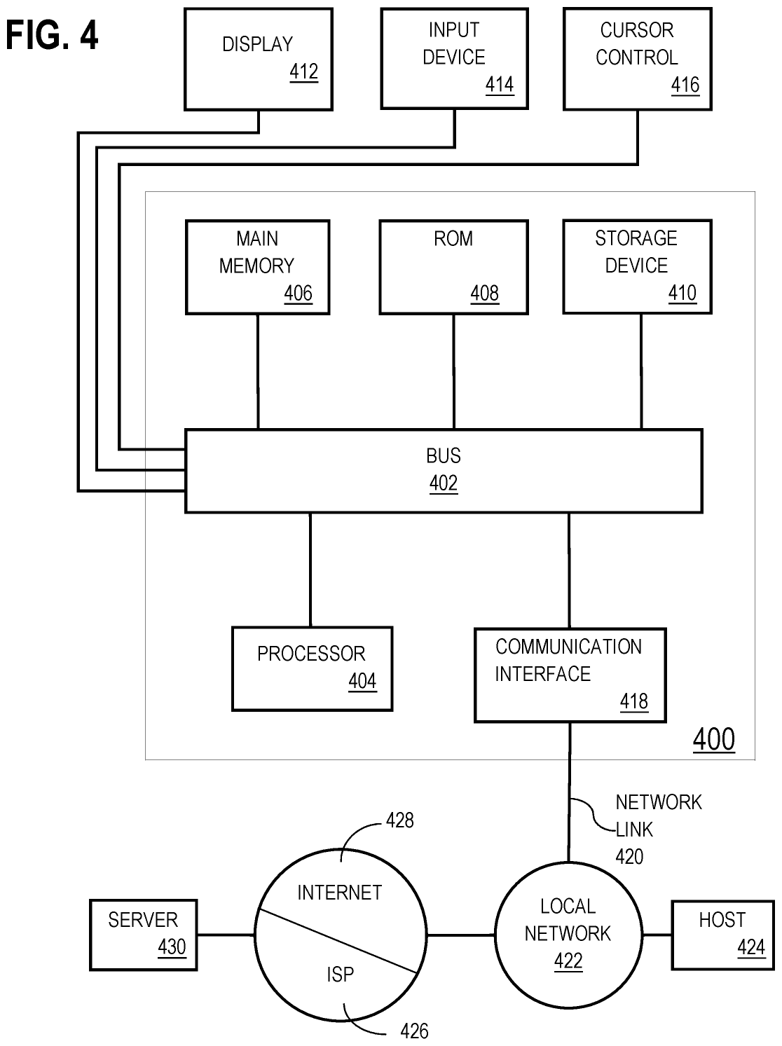

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
training a machine learning model to generate suggestions for remediation actions for remediating issues associated with data objects, the training comprising:
obtaining training data sets, each training data set comprising:
a particular set of one or more data objects associated with a particular issue; and
information indicating a remediation action for the particular issue for the particular set of one or more data objects;
training the machine learning model based on the training data sets;
receiving a target set of one or more data objects;
applying the machine learning model to the target set of one or more data objects, the applying comprising:
generating, by the machine learning model, a suggestion for remediating a first issue with the target set of one or more data objects; and
presenting, by a graphical user interface, an interface element representing the suggestion.

2. The non-transitory computer readable medium of claim 1, wherein the first issue comprises a non-mathematical relationship between different data objects or between different components of a same data object,
wherein the non-mathematical relationship was associated with a plurality of training data sets among the training data sets, and
wherein a particular remediation action corresponding to the suggestion was indicated in the plurality of training data sets.

3. The non-transitory computer readable medium of claim 1, wherein the first issue comprises a mathematical relationship between different data objects or between different components of a same data object,
wherein the mathematical relationship was associated with a plurality of training data sets of the training data sets, and
wherein a particular remediation action corresponding to the suggestion was indicated in the plurality of training data sets.

4. The non-transitory computer readable medium of claim 1, wherein presenting the interface element includes visually identifying cells in a spreadsheet representing a subset of the target set of one or more data objects.

5. The non-transitory computer readable medium of claim 1, wherein each data object of the target set of one or more data objects includes a plurality of fields storing a respective plurality of values.

6. The non-transitory computer readable medium of claim 1, wherein the target set of one or more data objects includes at least one of a spreadsheet and a database record.

7. The non-transitory computer readable medium of claim 1, wherein the operations further comprise:
detecting a merger of values among two or more data objects; and
detecting the first issue with the target set of one or more data objects based on the merger of the values among the two or more data objects,
wherein applying the machine learning model to the target set of one or more data objects is responsive to detecting the first issue.

8. The non-transitory computer readable medium of claim 7, wherein detecting the merger of the values of the two or more data objects includes detecting a merger of a first set of values from a spreadsheet and a second set of values from a database record,
wherein detecting the first issue with the target set of one or more data objects comprises detecting an anomaly in one of the spreadsheet and the database record resulting from the merger.

9. The non-transitory computer readable medium of claim 1, wherein presenting the interface element representing the suggestion comprises:
generating a selectable task card icon in a first region of a graphical user interface (GUI) while displaying one or more fields associated with the first issue in a second region of the GUI different from the first region.

10. The non-transitory computer readable medium of claim 9, wherein the operations further comprise:
detecting a selection of the task card; and
responsive to detecting the selection of the task card: changing data displayed in the second region of the GUI from a first set of data excluding any value associated with the first issue to a second set of data including at least one value associated with the first issue.

11. The non-transitory computer readable medium of claim 9, wherein training the machine learning model includes training the machine learning model to identify a category associated with the first issue,
wherein the operations further comprise:
presenting the category together with the task card.

12. The non-transitory computer readable medium of claim 9, wherein training the machine learning model includes training the machine learning model to identify a priority level associated with the first issue,
wherein the operations further comprise:
identifying a plurality of issues in the target set of one or more data objects;
generating, by the machine learning model, (a) priority values associated with the respective plurality of issues, and (b) a respective plurality of suggestions for remediating the plurality of issues; and
determining a first priority value associated with the first issue exceeds a second priority value associated with a second issue;
responsive to determining a first priority value associated with the first issue exceeds a second priority value associated with a second issue:
presenting, by the graphical user interface (GUI), the interface element representing the suggestion; and
refraining from presenting, by the GUI, any interface element representing a suggestion corresponding to the second issue.

13. The non-transitory computer readable medium of claim 1, wherein the first issue is an anomaly in the target set of one or more data objects.

14. A method comprising:
training a machine learning model to generate suggestions for remediation actions for remediating issues associated with data objects, the training comprising:
obtaining training data sets, each training data set comprising:
a particular set of one or more data objects associated with a particular issue; and
information indicating a remediation action for the particular issue for the particular set of one or more data objects;
training the machine learning model based on the training data sets;
receiving a target set of one or more data objects;
applying the machine learning model to the target set of one or more data objects, the applying comprising:
generating, by the machine learning model, a suggestion for remediating a first issue with the target set of one or more data objects; and
presenting, by a graphical user interface, an interface element representing the suggestion.

15. The method of claim 14, wherein the first issue comprises a non-mathematical relationship between different data objects or between different components of a same data object,
wherein the non-mathematical relationship was associated with a plurality of training data sets among the training data sets, and
wherein a particular remediation action corresponding to the suggestion was indicated in the plurality of training data sets.

16. The method of claim 14, wherein the first issue comprises a mathematical relationship between different data objects or between different components of a same data object,
wherein the mathematical relationship was associated with a plurality of training data sets of the training data sets, and
wherein a particular remediation action corresponding to the suggestion was indicated in the plurality of training data sets.

17. The method of claim 14, wherein presenting the interface element representing the suggestion comprises:
generating a selectable task card icon in a first region of a graphical user interface (GUI) while displaying one or more fields associated with the first issue in a second region of the GUI different from the first region.

18. The method of claim 17, further comprising:
detecting a selection of the task card; and
responsive to detecting the selection of the task card: changing data displayed in the second region of the GUI from a first set of data excluding any value associated with the first issue to a second set of data including at least one value associated with the first issue.

19. The method of claim 17, wherein training the machine learning model includes training the machine learning model to identify a priority level associated with the first issue,
wherein the method further comprises:
identifying a plurality of issues in the target set of one or more data objects;
generating, by the machine learning model, (a) priority values associated with the respective plurality of issues, and (b) a respective plurality of suggestions for remediating the plurality of issues; and
determining a first priority value associated with the first issue exceeds a second priority value associated with a second issue;
responsive to determining a first priority value associated with the first issue exceeds a second priority value associated with a second issue:
presenting, by the graphical user interface (GUI), the interface element representing the suggestion; and
refraining from presenting, by the GUI, any interface element representing a suggestion corresponding to the second issue.

20. A system comprising:
one or more processors; and
memory storing instructions that, when executed by the one or more processors, cause the system to perform:
training a machine learning model to generate suggestions for remediation actions for remediating issues associated with data objects, the training comprising:
obtaining training data sets, each training data set comprising:
a particular set of one or more data objects associated with a particular issue; and
information indicating a remediation action for the particular issue for the particular set of one or more data objects;
training the machine learning model based on the training data sets;
receiving a target set of one or more data objects;
applying the machine learning model to the target set of one or more data objects, the applying comprising:
generating, by the machine learning model, a suggestion for remediating a first issue with the target set of one or more data objects; and
presenting, by a graphical user interface, an interface element representing the suggestion.
